(19) United States
(12) Patent Application Publication
(10) Pub. No.: US 2025/0366448 A1
(43) Pub. Date: Dec. 4, 2025

(54) LAND-BASED SHRIMP AQUACULTURE

(71) Applicant: Anthony P. Brand, Coker, AL (US)

(72) Inventors: Maurice C. Kemp, Litchfield Park, AZ (US); Anthony P. Brand, Coker, AL (US)

(73) Assignee: Anthony P. Brand, Coker, AL (US)

(21) Appl. No.: 18/810,226

(22) Filed: Aug. 20, 2024

Related U.S. Application Data
(60) Provisional application No. 63/520,639, filed on Aug. 20, 2023.

(51) Int. Cl. A01K 63/04

(52) U.S. Cl. CPC A01K 63/042; A01K 61/59; A01K 63/003

(57) ABSTRACT

Embodiments are directed to an advanced, modular, and scalable system integrating a Dissolved Gas Infusion (DGI) system and a Programmable Logic Controller (PLC) to automate and optimize processes such as water filtration, oxygenation, and waste management. The DGI system infuses high-purity oxygen directly into the water, maintaining optimal dissolved oxygen (DO) levels from the post-larvae stage to harvest, and significantly reducing oxygen wastage compared to traditional bubble aeration processes. The system includes modular raceways with load-bearing support beams, twist locks for secure stacking, and observation ports for easy access. This innovative approach ensures efficient, cost-effective, and reliable shrimp production, leading to higher survival rates, faster growth, and improved overall health of the shrimp.

### CROSS REFERENCE TO RELATED APPLICATIONS

This application claims the benefit of the filing date of U.S. Provisional Patent Application No. 63/520,639, filed Aug. 20, 2023, the disclosure of which is hereby incorporated by reference herein in its entirety.

### BACKGROUND

Aquaculture involves breeding, raising, and harvesting aquatic organisms, such as finfish and shellfish in freshwater and saltwater environments. This is done for human consumption, conservation of aquatic life, and promotion of recreational activities. To ensure the survival and optimal growth of these organisms, it is important to maintain their environmental and nutritive requirements. Finfish and shrimp are cultured at a higher biomass than other organisms to meet consumer demand. Any deviation from the requirements for removal of total dissolved solids (TDS), inorganic and organic solids (nitrogenous waste products of metabolism), total suspended solids (TSS), silt, clay, algae, and oxygenation can result in death of these animals.

Technological innovation drives control and improvement in shrimp aquaculture. Integrating ever-newer technology, including selecting improved genetic strains, allows for increased shrimp production with lower costs and higher yields. Moreover, because of ever-increasing demand, the effects are not just local. Technological innovation is seen as a competitive advantage. Shrimp aquaculture is effective with four recognized versions.

Version 1 refers to intensive aquaculture production methods whose densities are low, control is minimal, and the results cannot be predicted. There is a great deal of variation in the results depending on the natural conditions.

Version 2 reflects increased stocking density, additional water changes, and the introduction of aeration, supplementary feeding, and timed feeders, which all facilitate enhanced control. Results vary, however, and are uncertain in many cases.

Version 3 addressed analyzing and recording process information statistically to make informed decisions. With greater control over the process and better processing of the information, more accurate estimation of future results are possible. By doing so, aquaculture will be able to move forward on the path of continuous improvement.

Version 4, which takes advantage of the internet, mobile devices, robotics, Big Data, Artificial Intelligence (AI), the Internet of Things (IoT), and other technologies, facilitated the ability to model, simulate, and predict prospective results with relatively low margins of error.

Despite gains from technology, the industry has been slow to adopt newer technology for several reasons: high cost, lack of knowledge, government regulations, and uncertainties in the market. New technologies can be expensive, and many shrimp farmers are small-scale operators who cannot afford the upfront costs.

Apart from the perceived risk, there are other determinative factors that have direct implications as to whether technology may be incorporated. A major factor in this regard is intensity. Applying pond-based shrimp production, intensity can be broken up into extensive, semi-intensive, and intensive, with the highest yields being from intensive. On an international scale, about 25-30% of the world's shrimp production is from semi-intensive farms. These are mostly Version 1 and Version 2 operations (i.e., low-tech, labor-intensive operations for the most part). This observation alone begs the question, why would I want to change from a low-tech to a high-tech approach to growing shrimp? The following illustrates why.

The Food and Agriculture Organization of the United Nations (FAO) predicts that shrimp will experience the greatest increase in demand over the next few decades out of all animal protein commodities in the seafood industry. As a result of the growth of aquaculture, which has become the primary source of shrimp production, global shrimp production doubled between 2003 and 2016. As described above, incorporation of technologies allows the passage from previous Aquaculture versions to version 4.0, in which costs are minimized and yields are maximized.

By volume, farmed shrimp is the most valuable seafood commodity traded worldwide. Despite shrimp aquaculture's rapid growth, it is not without its challenges. The industry is characterized by unindustrialized producers and unsustainable practices. As a result, natural resources are heavily utilized, which can have negative effects without proper management. Among these impacts are habitat conversion, water pollution, overexploitation of marine fisheries for fish meal, and carbon dioxide emissions associated with electricity and farm fuel. One solution for reducing the use of land, water, and energy in shrimp production is controlled intensification which is a type of aquaculture that uses more precise methods to produce shrimp at higher levels of input and output per unit of land area.

The performance of aquaculture, in general, is almost directly tied to the production methods used. Water use and treatments are highly dependent on the infrastructure design. Furthermore, management can significantly change the performance of the farm, even with the same infrastructure. Different biotechnologies have been developed to reduce the use of antibiotics, maximize the Feed Conversion Ratio (FCR), minimize energy and water consumption, and improve wastewater outputs.

In the late 20th century, shrimp production in the United States was carried out in the manner described in Version 2 above. It is important to note, however, that few of these operations are still in operation due to climate, regulations, and other factors such as labor costs. To counter these issues, the American shrimp industry, in effect, moved offshore. Notably, the technology did not change.

International shrimp production made gains as compared to Europe and the United States because of advantages, such as climate, lower labor costs, lower land costs, and minimal government regulations. However, only one country dramatically increased production, that is Ecuador. It is now the largest shrimp producer outside China, reflecting the implementation of new technology. The impact was dramatic; at present, extensive and semi-intensive producers cannot compete, and commodity prices continue to be driven down. Producers are failing and will continue to do so.

Producers, particularly in southeast Asia, are desperate, and commodity shrimp are being dumped onto the market. The public has been made aware of the issues, a consensus is developing that commodity shrimp imports are contaminated with harmful bacteria, such as Vibrio parahaemolyticus and Salmonella spp. These bacteria can cause food poisoning, which leads to symptoms such as nausea, vomiting, diarrhea, and fever. Things that can be done to reduce the risk of contamination of imported shrimp include improved inspection and testing along with better traceability, and education and training for handlers, but cheap shrimp is not conducive to planned risk strategies for risk reduction.

Locally grown shrimp is often seen as being safer than imported shrimp since it is produced closer to home and is subject to stricter food safety standards. Additionally, locally grown shrimp is often fresher than imported shrimp, which can also reduce the risk of contamination. However, locally sourced shrimp for Europeans and Americans production is limited mostly due to climatic conditions. Production, in effect, has not changed much over a 20-year period starting in the late 20th century. What has changed is an awareness that production has to be directed towards at-scale land-based production. While technology evolves an alternative to currently used Recirculating Aquaculture Systems (RAS) has to be put in place.

RAS generally includes a means for removing solids, denitrification process to remove nitrates, a filter coated with nitrifying aerobic bacteria for conversion of ammonia to nitrites and nitrites to nitrates in a step wise process. These steps are carried out in a continuous loop to remove nitrogen metabolites.

Some systems include a step to eliminate shrimp pathogens. Specifically, RAS water is passed through an ultra-violet (UV) light source. Short wavelength UV will kill bacteria but likely is ineffective for the control of viral pathogens.

RAS does provide means for reprocessing water in which shrimp are grown. RAS provides greater control and stability, while increasing costs. In addition, there is often a requirement for construction of a production plant and installation of an uninterrupted power supply.

Operators must be highly trained in the management of parameters including oxygenation, pH, etc. Moreover, RAS systems are much more complex and expensive than Biofloc Technology (BFT)

Originally created to clean water naturally, BFT has gained popularity as a low-cost, sustainable aquaculture alternative to RAS. Among the advantages are water conservation, faster growth, reduced susceptibility to disease, and a more efficient use of feed protein. With BFT, feed requirements are lower, yields are higher, and sustainability is assured.

Protein-rich flocks provide vitamins and phosphorus to the animals while improving water quality dynamics and sequestering toxic nitrogen byproducts. The system generally maintains lower mortality rates and increases shrimp growth rates. Bacteria are both cleaners and nutritional sources. Environmental impacts are relatively low due to limited (or near zero) water exchange.

The main disadvantage of BFT is that it requires a startup period before the flock is established resulting in inconsistent yields. Composition of the flock depends on what blows in, which can negate all its benefits. The management of industrial-scale BFT is challenging. As a biologist and technician, the system manager must be skilled. BFT has pretty much all the standard disadvantages of RAS, namely a high capital investment per unit area, a high energy input and a requirement for electricity and aeration.

Positive attributes of RAS include:
If correctly designed, built, and operated, RAS is time independent and will provide the same results in ten years as it did when it was first launched. BFT usually starts very well and then suffers a performance drop-off after 2-3 years of operation,
A correctly designed RAS should not produce any sludge,
Scaling of RAS is a linear operation based on mechanics; however, scaling of BFT is often dependent on non-linear biological interactions which are far more difficult to predict, meaning much less control,
Computer based technology is provides real time systems for physical parameter control, and
A well-designed RAS system has negligible environmental impact, allowing RAS farms to be virtually anywhere.

Negative aspects of RAS that still require work include:
RAS operations have a high energy demand,
RAS operations require highly skilled staff to operate. RAS experts are currently in short supply globally,
To meet shrimp's specific environmental requirements, certain modifications must be made. An example is, modification is to provide sufficient water flow, for effective filtration whilst still allowing the shrimp to maintain their position, and
Less obvious, but of major concern, is the interdependence of physical and biological processes, and scalability.

Despite its complexity and cost, RAS made it possible to move production indoors. Shrimp producers who rely on RAS are scattered worldwide and for Europe, America and Canada, dependence is near absolute. Moreover, producers in these areas are now able to produce high quality, larger quantities of shrimp, for the domestic market,

RAS systems in Europe, America and Canada, now provide a product, whose value exceeds the cost of inputs. However, none of these operations have been scaled such as to compete with imports.

### SUMMARY

Land-based shrimp aquaculture faces numerous challenges, including maintaining optimal water quality, ensuring adequate oxygenation, and managing waste products. Traditional methods of shrimp farming, such as pond-based systems, often struggle with these issues due to their reliance on natural conditions and limited control over environmental factors. As a result, shrimp farmers frequently encounter problems related to water pollution, disease outbreaks, and inconsistent yields.

Recirculating Aquaculture Systems (RAS) have been developed to address some of these challenges by providing a controlled environment for shrimp production. RAS typically includes components such as mechanical and biological filters, denitrification processes, and UV light sources for pathogen control. However, RAS has several disadvantages. The high energy consumption required for continuous water circulation and filtration, coupled with the need for skilled labor to manage the system, makes RAS expensive to operate. Additionally, the interdependence of physical and biological processes in RAS can lead to system failures if any component malfunctions, resulting in potential disease transmission and water quality issues.

Biofloc Technology (BFT) offers an alternative approach to shrimp farming by using microbial communities to maintain water quality and provide additional nutrition to the shrimp. While BFT can reduce water usage and improve feed efficiency, the technology also has drawbacks. The startup period required to establish a stable biofloc community can result in inconsistent yields, and the system's performance is highly dependent on the skill of the manager. Furthermore, BFT shares many of the same disadvantages as RAS, including high capital investment, energy requirements, and the need for aeration.

The disclosed approach presents a novel method to land-based shrimp aquaculture by integrating advanced water reprocessing and oxygenation technologies into a modular, scalable system. This system aims to overcome the limitations of traditional RAS and BFT by providing a more efficient, cost-effective, and reliable solution for shrimp production. The method includes a Programmable Logic Controller (PLC) to automate and optimize various processes, such as water filtration, oxygenation, and waste management. By separating production into standalone modules, the system reduces the risk of contamination and allows for easier scalability and maintenance.

According to one embodiment, a system for land-based aquaculture comprises a dissolved gas infusion system configured to infuse high-purity oxygen into a slipstream of water, and at least one raceway comprising one or more injectors coupled to the dissolved gas infusion system and configured to introduce oxygen-infused water into the raceways, and one or more dissolved oxygen sensors configured to monitor oxygen levels in water in the raceways.

According to another aspect, the system further comprises a plurality of raceways arranged in a vertical stacked configuration, each raceway further comprising a rectangular structure with an upper portion and a lower portion, and a basin structure formed in the lower portion of the raceway, the basin having a central vertical barrier and configured to circulate water around the barrier.

According to yet another aspect, the system further comprises a drain in each raceway, and a water reprocessing system coupled to the drain and configured to receive water from the raceways, the water reprocessing system comprising filters for removing solids and nitrogenous byproducts from water, and pumps for circulating water through the system.

According to another aspect, the dissolved gas infusion system and the water reprocessing system are configured to maintain optimal water quality and dissolved oxygen levels for shrimp production.

According to yet another aspect, the system further comprises a cover for a topmost raceway in the vertical stack, the cover comprising multiple overlapping sections configured to provide closure to the topmost raceway and to prevent external contamination.

According to another aspect, the dissolved gas infusion system is configured to achieve an oxygenation level in the slipstream of water of up to 300 pounds per square inch gauge (psig).

According to yet another aspect, the dissolved gas infusion system further comprises one or more high-purity oxygen tanks connected to a saturator.

According to another aspect, the raceways further comprise load-bearing support beams arranged laterally along the sides of the raceway.

According to yet another aspect, the raceways further comprise twist locks located at the top and bottom of each load-bearing support beam for securing the raceway to adjacent raceways in a vertical stack.

According to another aspect, the raceways further comprise a harvest pit located at one end of the basin structure, the harvest pit having a crescent shape and angled tangentially down to a lowest point.

According to yet another aspect, the raceways further comprise a drain hole in the basin structure, a first valve coupled to the drain hole and configured to control a screen that is sized to retain animals in the basin, wherein, when the first valve is open, the screen is adapted to divert waste and detritus to a water reprocessing system, and a second valve coupled to the drain hole and configured to allow water and animals to drain from the raceway when opened. According to another aspect, the animals are shrimp or fin fish.

According to yet another aspect, the system further comprises two dissolved oxygen sensors in each raceway, the dissolved oxygen sensors located on a basin floor on opposite sides of the barrier.

According to another aspect, each dissolved oxygen sensor is positioned upstream of an injector located on a same side of the barrier.

According to yet another aspect, the injectors are controlled by a programmable logic controller (PLC) to adjust the rate of oxygen infusion based on real-time dissolved oxygen levels detected by the dissolved oxygen sensors.

According to another aspect, the injectors are configured to introduce oxygen-infused water into the raceways at multiple locations along the length of the raceway to ensure balanced oxygenation.

According to yet another aspect, the injectors are designed to produce microbubbles to maximize the surface area for oxygen transfer and enhance the efficiency of oxygenation.

According to another aspect, the injectors are configured to operate at variable pressures to optimize the infusion of oxygen into the water based on the biomass and oxygen demand of animals growing in the water.

According to yet another aspect, the injectors are positioned to create a circular flow pattern in the basin.

According to another aspect, the basin structure has a racetrack shape centered around the central vertical barrier, the basin structure having a floor comprising a central flat portion, an inner sloped portion that rises from the flat portion to meet the central barrier, and an outer sloped portion that rises from the flat portion to meet an outer wall of the rectangular structure.

According to yet another aspect, the dissolved gas infusion system is configured to maintain optimal dissolved oxygen (DO) levels for shrimp growth from the post-larvae stage to harvest by adjusting a DO set point according to biomass of the shrimp.

According to another aspect, the dissolved gas infusion system infuses high-purity oxygen directly into the water as dissolved oxygen, thereby reducing the amount of oxygen required compared to traditional bubble aeration processes by ensuring that nearly all the oxygen is available to animals in the water.

The present system integrates advanced DGI technology with a modular, scalable raceway system for land-based shrimp aquaculture; unlike traditional RAS and BFT systems, which have limitations such as high energy consumption, complex management, and inconsistent yields, this invention offers a more efficient, cost-effective, and reliable solution. Some of the unique elements include:

Dissolved Gas Infusion (DGI) System. The DGI system infuses high-purity oxygen directly into the water as dissolved oxygen, ensuring nearly all the oxygen is available to the shrimp. This method significantly reduces oxygen wastage compared to traditional bubble aeration processes, leading to cost savings and more sustainable operations. The DGI system produces dissolved oxygen that is distributed on demand into the raceway water. The dissolved oxygen is bioavailable, which refers to the portion of dissolved oxygen in the water that is readily accessible and usable by shrimp or fish for respiration. Aquatic animals, such as shrimp, require oxygen dissolved in water to survive, and the term “bioavailable” highlights that this oxygen must be in a form and concentration that shrimp can absorb through their gills to support their metabolic processes. In nature, oxygen is dissolved in water from the atmosphere and through photosynthesis by aquatic plants. This dissolved oxygen is what fish utilize to breathe. Adequate levels of bioavailable oxygen are crucial for the health of fish. If the bioavailable oxygen level drops too low (a condition known as hypoxia), fish may become stressed, exhibit erratic behavior, or even die. In summary, bioavailable oxygen in water refers to the dissolved oxygen that is in a form and concentration that fish can effectively use to sustain life.

Programmable Logic Controller (PLC). The PLC automates and optimizes various processes, such as water filtration, oxygenation, and waste management. It dynamically adjusts the rate of oxygen infusion based on real-time dissolved oxygen levels detected by sensors, ensuring consistent oxygenation regardless of biomass changes.

Modular, scalable raceways. The raceways are designed to be modular and scalable, allowing for easy expansion and maintenance. Each raceway includes features such as load-bearing support beams, twist locks for secure stacking, observation ports for easy access, and a unique basin structure with a central vertical barrier to facilitate water circulation.

Efficient water circulation and waste management. The injectors are positioned to create a circular flow pattern in the basin, enhancing water circulation and preventing the buildup of detritus. The system also includes a water reprocessing system with filters, pumps, a hydrocyclone clarifier, and an activated carbon column to maintain optimal water quality.

Optimized oxygenation. The injectors are designed to produce microbubbles, maximizing the surface area for oxygen transfer and enhancing the efficiency of oxygenation.

They operate at variable pressures to optimize the infusion process based on the biomass and oxygen demand of the shrimp.

These features collectively provide a more effective and sustainable approach to land-based shrimp aquaculture, addressing the limitations of existing systems and ensuring higher survival rates, faster growth, and improved overall health of the shrimp.

### BRIEF DESCRIPTION OF THE DRAWINGS

Having thus described the invention in general terms, reference will now be made to the accompanying drawings, which are not necessarily drawn to scale, and wherein:

FIG. 1 illustrates the layout of a dissolved gas infusion and circulation system according to an example embodiment.

FIG. 2 illustrates shrimp growth rates during two trials evaluations of the dissolved gas infusion and circulation system disclosed herein.

FIG. 3 illustrates oxygen demand and corresponding process water flow over a trial period.

FIGS. 4A and 4B illustrate dissolved oxygen trends on different days during a trial period.

FIG. 5 illustrates a modular, scalable, resource-conserving aquaculture platform according to an example embodiment.

FIG. 6 illustrates an individual raceway that can be positioned anywhere in a raceway stack.

FIG. 7 illustrates a process for stacking raceways.

FIGS. 8A and 8B illustrate the operation an observation port in a raceway.

FIG. 9 illustrates a cover 502 installed on a topmost raceway.

FIG. 10 illustrates a caisson structure on which raceways can be installed according to one embodiment.

FIG. 11 illustrates a dovetail twist lock for use on each corner of a caisson.

FIG. 12 illustrates a stacking cone for use on an edge of a caisson.

FIG. 13 is an isometric top view of a raceway that can be used as stacked raceways in an example embodiment.

FIGS. 14A-C provide top, side, and cross section views of a raceway along with dimensions according to an example embodiment.

FIG. 15 illustrates plumbing for removing water, waste, and animals from raceways.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The use of a Recirculating Aquaculture System (RAS) made sustainable aquaculture possible. RAS allows for healthier shrimp, lowers water consumption, and shortens transport distances as shrimp can be grown closer to the markets. By controlling cultural conditions, RAS made it possible to establish seafood production almost anywhere, regardless of local climatic conditions.

Despite the benefits of RAS, there are drawbacks that need to be addressed. The first issue that needs to be dealt with is an environmental issue. The energy consumption required to produce a kilogram of shrimp in a conventional system is 3 kWh/kg and 4.3 kWh/kg in RAS. The use of water pumps and several other pieces of equipment quickly add to the energy requirements of for RAS. The problem with energy is mainly associated with its source. If the energy used to recirculate comes from fossil fuel combustion, this means an increase in greenhouse gas emissions. On the other hand, if the energy comes from clean sources, the issue is much less significant in terms of sustainable production.

Another RAS issue is the capital investment required and the higher total costs of production. A RAS has higher infrastructure, equipment, and energy requirements and more specialized labor requirements. Furthermore, RAS production requires more capital to operate and higher initial investment. Despite this, the automation of farms and the higher productivity result in higher yields, which reduce average unit production costs, making this kind of system more profitable than traditional ones.

Over the last decades, much attention has been drawn to recirculating systems, making new and better approaches to improve energy use and water quality management, making it possible to produce very high yields with minimal land space. This is particularly interesting for countries where space is an issue or for farmers looking to produce nearer to the targeted markets disregarding the climatic challenges, such as temperature or water availability.

The technologies developed for RAS production have improved exponentially. For a more holistic approach, integrated water treatment systems, ultrafiltration systems, clean energy generators, and even multitrophic aquaculture are used. Some innovative examples of RAS production are observed in modular aquaculture, especially vertical aquaculture and container production.

RAS tends to be quite expensive and requires a skilled workforce, which negates the advantages of RAS. Of even more concern is whether the technology is viable for large-indoor land-based shrimp aquaculture, as exemplified in U.S. Pat. No. 11,206,817 entitled “Multi-Phasic Integrated Super-Intensive Shrimp Production System.” The installation size, risk of contamination, and operative error makes reliance on a single RAS dangerous.

RAS relies on the interdependence of physical and biological processes but, for the most part, ignores inherent risks of biological collapse or contamination with shrimp pathogens, such pathogens may be readily disseminated throughout a closed-loop water maintenance system. Such risks are untenable because they may lead to system collapse. Therefore, with risk reduction being the objective, embodiments disclosed herein have separated all aspects of production into standalone modules.

RAS offers advantages for shrimp farming, but it faces several hurdles economically. High construction costs have proven challenging in developing projects with sustainable economics. Key RAS economic issues include:
upfront costs,
efficient with respect to water use; however, it is energy-intensive due to constant filtration and aeration, requires skilled personnel, and retaining qualified staff can add to operational expenditures,
shrimp market fluctuations are common and small operations are vulnerable, and
shrimp production is often constrained by the inability to scale and/or operate disease-free.

A modular system operates quite differently than RAS. First, modularized components are constructed separately into functional units that can be integrated to execute a desired application. For example, a module necessary for water reprocessing can be integrated and controlled by a Program Logic Controller (PLC). Feed, water processing, PLCs, aeration, and distinct modules are all programmed to execute desired functions. When functional units are assembled and integrated, PLCs can control the assigned tasks.

Key economic benefits of modular systems over RAS:
much of the design work has already been done and the system design is a matter of integrating functional modules,
projects can ramp up quicker and be finished faster,
expansion can mean duplicating the facility so that existing staff already know the new system front and back,
provides built-in resiliency and helps minimize the risk,
if one of the systems goes down, it will not wipe out an entire stock of shrimp, and
if a business encompasses more than one modular system, one or more systems can be used to optimize systems.

A GEN 2 shrimp production system based on a modular approach is disclosed in U.S. Pat. Nos. 11,206,817, 11,617,354, the contents of which are incorporated by reference herein. Anticipating an unmet demand of 1.2 million pounds per annum, the design of a GEN 2 production plant, based on four modules, was completed. Each module is divided into twelve production units (eight stacks comprised of eight raceways). The most basic unit in which shrimp grow-out takes place is the production sub-unit, i.e., a single raceway. Therefore, each module is comprised of 96 identical custom-fabricated raceways).

The use of a modular approach means production can be scalable. If production cannot keep up, then additional modules can be assembled and put online. A new module can be fabricated and plugged in if new technology becomes available. Modular systems allow for automation and optimization of feeding, water treatment, and other processes, which leads to increased efficiency and productivity.

Existing ammoniotelic animal aquaculture systems require RAS or BFT. All ammonotelic animals (protozoans, crustaceans, platyhelminths, cnidarians, poriferans, echinoderms, fishes, and amphibian larvae/tadpoles) are extremely sensitive to nitrogenous byproducts of microbial decomposition, especially ammonia. As little as 0.6 ppm of free ammonia can prove toxic to many kinds of shrimp and fish. Free ammonia causes gill irritation and respiration problems leading to physiological stress and death. Ammonia is a preeminent issue with all ammoniotelic animals used for aquaculture purposes. Ammonia accumulation is the result of microbial decomposition of organic matter, such as excess feed and accumulated fecal matter. In addition to ammonia, decomposition leads to hypoxic oxygen levels and increased carbon dioxide levels. Carbon dioxide impedes gas exchange through the gills, causing hypercapnia, resulting in acidosis, and low Dissolved Oxygen (DO) increases the toxicity of ammonia for the shrimp.

Ammonia in water exists in two forms, i.e., as ammonium ions (NH4+), which are non-toxic, and as un-ionized toxic ammonia (NH3), which are highly toxic. The relative proportion of one or the other depends on water temperature and pH. As little as 0.6 ppm of free ammonia can prove toxic to many kinds of fish and shrimp, causing gill irritation and respiration problems leading to physiologic stress and death.

Aquaculture thrives today because of RAS, but as stated above, RAS tends to be quite expensive to operate, requiring a skilled workforce, and is not very efficient. Different aspects of water processing technologies are integrated into RAS, including aeration, degassing, and denitrification. Looking to decrease risk, scale appropriately, and increase efficiency, the approach disclosed herein institutes a methodology that the mariculture industry has failed to evaluate.

Aeration is a critical issue for shrimp and finfish production. Shrimp are euryhaline marine invertebrates that can survive large fluctuations in environmental salinity, from near-0 to 35 parts per thousand (ppt). DO is one of the most critical elements of water quality in any aquaculture operation because all aerobic aquatic organisms need a constant supply to thrive. This has meant a means of aeration has to be employed. Traditionally, this has been accomplished by a process in which air or concentrated oxygen is circulated through, mixed with, or dissolved in fresh or saline water. However, trying to calculate and establish a specific DO level is complicated by the salinity level and temperature of the water, to say nothing of the biomass of shrimp housed therein. Difficulty of oxygenating for new water using ambient air processing system.

Illustrative of the difficulty of oxygenating water using ambient air is simple physics. At equilibrium with one atmosphere of air pressure, water will contain dissolved gases whose partial pressures will sum to one atmosphere. Theoretically, neglecting gases such as argon and (for the moment) carbon dioxide, one atmosphere of dissolved gas pressure will essentially consist of 0.21 atmospheres of oxygen pressure and 0.79 atmospheres of nitrogen pressure. When it comes to the concentration of each of these molecules in the water, however, the apparent 4:1 ratio of nitrogen to oxygen does not hold true. In fact, at 20° C., the water will contain about 15.3 parts per million (ppm) of nitrogen and 9.3 ppm of oxygen at equilibrium-less than a 2:1 ratio. This difference is due to Henry's Law and the ability of water to dissolve gases. Stated another way, each ppm of dissolved nitrogen exerts a higher pressure than a dissolved ppm of oxygen.

DO is non-compound oxygen, or free oxygen (O2). DO is oxygen that is not bonded to any molecules within water. The bonded oxygen molecule in water (H2O) is in a compound and does not count toward DO levels. From a physical perspective, the DO decreases exponentially as salt levels increase (i.e., at the same pressure and temperature). Saltwater holds about 20% less DO than freshwater. There is also an inverse relationship between DO and temperature (i.e., as the temperature of the water increases, DO levels decrease). The usual response to a depressed DO is to restrict stocking densities, such that capacity is not exceeded, or to take chances with what nature has provided. However, when shrimp aquaculture is moved indoors, all physicochemical, biological, and monetary parameters are in play to maximize production.

From a business perspective, the objective is to maximize the amount of shrimp that can be produced at the lowest cost and sell at the highest gain. Accordingly, a producer will increase stocking density to maximize yield. The result is ever-higher physicochemical demand, particularly with respect to oxygen. To meet this demand, several techniques have been employed, including RAS. Other than RAS, nanobubble generators, oxygen cones, and venturi aerators are used. All these systems have one thing in common-gas bubbles through water, creating a suspension of trapped gas. The trapped gas is not DO. In fact, the bubble contents will be a 2:1 ratio of nitrogen-to-oxygen ratio, meaning the amount of DO will be small.

The Multi-Phasic Integrated Super-Intensive Shrimp Production System disclosed in U.S. Pat. No. 11,206,817 is a synchronous shrimp production system. All aspects must be controlled to maximize production, especially oxygenation and removal of toxic by-products of metabolism, principally ammonia and carbon dioxide. Physicochemical properties and oxygenation are difficult using a traditional RAS even though the system was designed around control of the physicochemical and oxygenation properties. In other aquaculture systems, the use of nanobubble technology and other methods for oxygenation has resulted in accelerated marine animal growth and a reduction in feed costs. Accelerated growth alone could mean more production.

One of the problems faced by the aquaculture industry is finding an economical method of introducing higher levels of oxygen into the water on a defined, consistent basis. Introducing ever more amounts of air into the water to increase oxygen availability is almost self-defeating (i.e., you are adding more than two times as much nitrogen as compared to oxygen). Moreover, even oxygen by itself, if dispersed by a bubble process, is still not available because it does not represent DO being bubbled through the water. High concentrations are hard to achieve, and response to oxygen demand is slow.

Understanding the issue, engineers have developed techniques that do not rely on bubbling large amounts of oxygen into the water with a short half-life to increase oxygenation. The Dissolved Gas Infusion (DGI) system developed by Fuel Tech, Inc. is one such system. The DGI system is not limited by the typical atmospheric saturation. Oxygenation is controlled by a PLC that infuses DO and the DO level can be set well beyond 30 mg/L (i.e., well beyond the toxic level for aquaculture animals). Importantly, once a setpoint is established, the oxygen level can be maintained if highly concentrated oxygen is available. The DGI system delivers oxygen to the water on demand.

### Dissolved Gas Infusion for Oxygenation of Water

Aeration of natural water and wastewater is essential to the biological and chemical processes that convert contaminants to safe by-products and sustain the aquaculture environment. The goal of aeration is to increase DO for biological and chemical processes. The concentration of nitrogen in air limits the rate of aeration that can provide DO. A pure oxygen source is a better alternative. The effectiveness of converting oxygen from gas bubbles into DO molecules in water depends on the size of the bubbles and the water depth. Once the bubbles reach the water's surface, their oxygen is lost. In fact, if the oxygen remains in bubbles, it is not available for utilization in the aqueous system.

The DGI system was developed to significantly increase the rate at which DO can be introduced into a water treatment process. The system uses a combination of technologies and scientific principles to accomplish this, such as those disclosed in U.S. Pat. No. 11,642,634, the disclosure of which is incorporated by reference herein in its entirety. The DGI system uses a proprietary saturator to pre-dissolve (infuse) high-purity oxygen into a slipstream at pressure. The high-purity oxygen and the slipstream are necessary to achieve the oxygenation goals of the application, which are up to 300 pounds per square inch gauge (psig).

### DGI and Circulation System

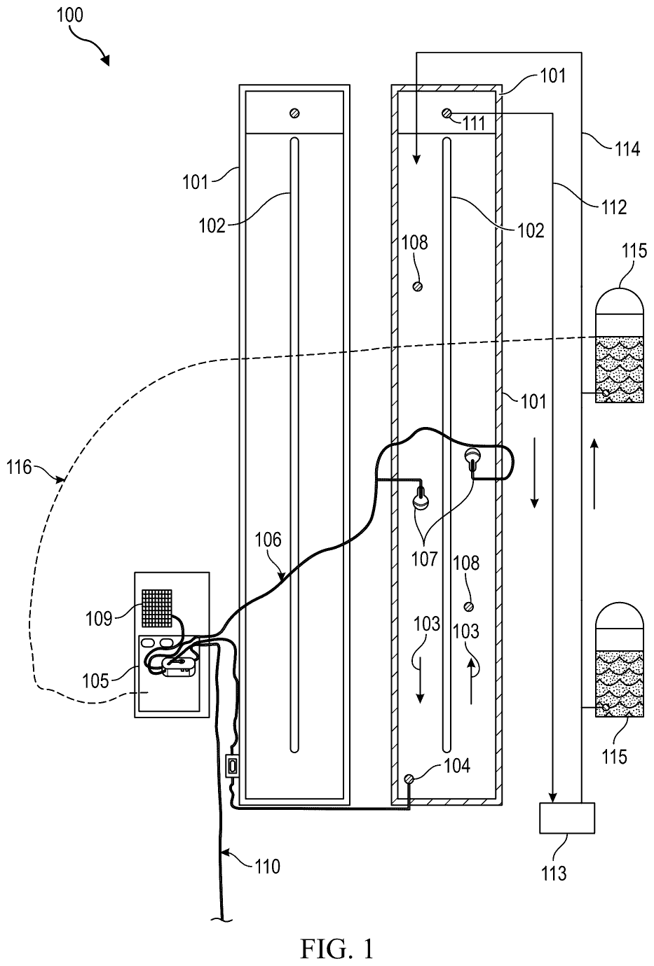

FIG. 1 illustrates the layout of a DGI and circulation system 100 according to an example embodiment. The system includes a plurality of concrete raceways 101 having a center barrier 102. Water in raceway 101 circulates in a counterclockwise direction 103 around barrier 102 in the illustrated example. Shrimp are grown in the water. Operationally, a slipstream of water is captured from the raceway at 104 and is sent to a skid-mounted filtering module 105 that includes filters, high pressure pumps, and other equipment for oxygen saturation under control of a PLC (“the DGI saturator”). The filtering module 105 infuses the captured water slipstream with high-purity oxygen. Water from raceway 101 is drawn into the DGI saturator 105 via pumps and is pressurized to a desired operating pressure. The DGI saturator 105 is a high-efficiency device optimized for energy efficiency and infusion efficiency. Oxygen-laden water then exits the DGI saturator 105 and flows through lines 106 to injectors 107. A stream of oxygen-infused raceway water is sent through the injectors 107 at two locations on opposite sides of the raceway barrier 102 to provide balanced oxygenation. The amount of oxygen injected is controlled by two probes 108 (e.g., DO sensors) installed in the raceway just upstream of the injection points 107 to ensure a well-diffused DO measurement and control signal. Oxygen is provided to DGI saturator 105 from one or more oxygen tanks 109. Water can be provided to DGI saturator 105 from an external source via hose 110.

The operation of the water injectors 107 is designed to ensure efficient and balanced oxygenation throughout the raceways. The injectors introduce high-purity oxygen-infused water into the raceways at multiple locations along their length, creating a uniform distribution of dissolved oxygen. Positioned on opposite sides of the central vertical barrier in the basin, the injectors facilitate a circular flow pattern, enhancing water circulation and preventing the buildup of detritus. Controlled by a Programmable Logic Controller (PLC), the injectors adjust the rate of oxygen infusion based on real-time dissolved oxygen levels detected by sensors. This dynamic adjustment ensures that the oxygen demand of the shrimp is met consistently, regardless of biomass changes. The injectors are designed to produce microbubbles, maximizing the surface area for oxygen transfer and enhancing the efficiency of oxygenation. Additionally, they operate at variable pressures to optimize the infusion process, ensuring that nearly all the oxygen is available to the shrimp, thereby minimizing oxygen wastage and promoting sustainable shrimp farming operations. Although only two injectors are illustrated in the example embodiment (i.e., one on each side of the center barrier), it will be understood that in other embodiments any number and configuration of injectors may be used in the raceway.

Raceway 101 has a drain 111. Water, waste, and other contents removed from raceway 101 via drain 111 are passed via hose 112 to a sludge precipitation box 113. After sludge is removed in sludge precipitation box 113, cleaned water can be returned to raceway 101 via hose 114. One or more water reserve tanks 115 may be used to store water onsite with the raceways. Water from tanks 115 may be added to raceway 101 using hose 114. Additionally, water from tanks 115 may be provided via line 116 to DGI saturator 105, which can add oxygen to the water before injecting the oxygen-infused water at injectors 107.

### Demonstration Showing Shrimp Growth at Elevated Dissolved Oxygen Levels

Pacific white leg shrimp (Litopenaeus vannamei) are one of the most widely cultivated shrimp in the world with typical growth cycles ranging from 90 to 120 days. A trial was conducted to determine the effects of growing this shrimp with high biomass loading (more than 7 kg/m² at maturity) in typical low-salinity water by using an oxygen infusion process to provide raceway dissolved oxygen concentrations more than atmospheric saturation.

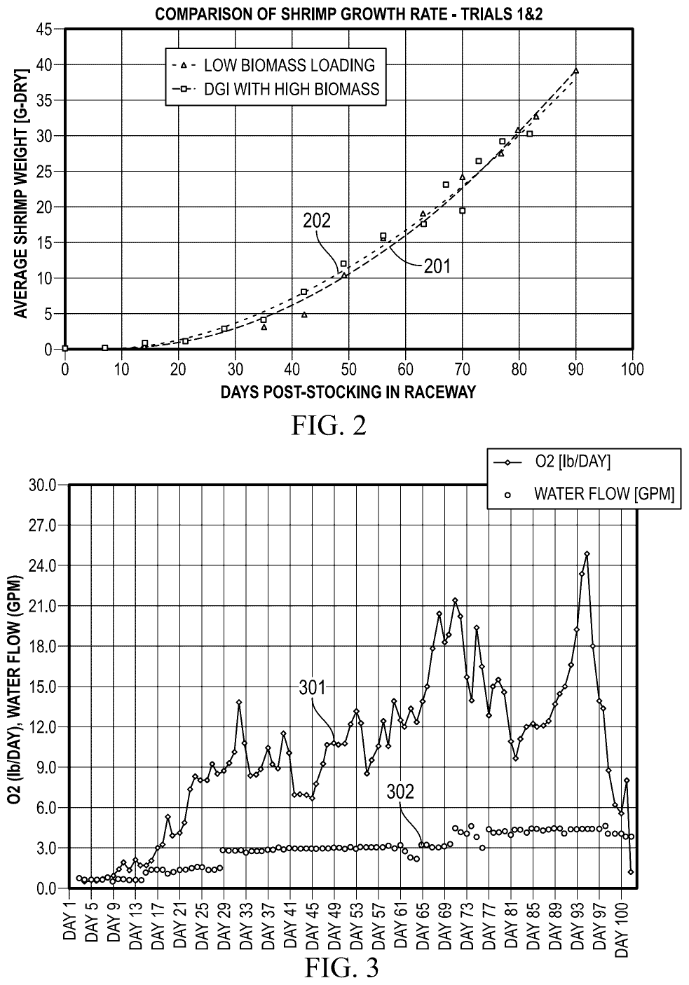

Two three-month trials (100-day nominal maturation) were conducted in a greenhouse-enclosed concrete raceway with a bottom area of 97.9 m² and an average water depth of 57 cm. A comparison of the growth rate of Trials 1 and 2 is shown in FIG. 2.

In both cases, the water was held at about 30° C. with a salinity of about 13 ppt (saturated with dissolved marine salts), which exhibited a DO of ˜7 mg/L. Using this level as a baseline, it was decided to execute a trial to assess the effects of highly enriched DO on shrimp growth and weight gain. Based on the above dissolved gas levels, dissolved gas levels between 9.5 mg/L and 11.5 mg/L, for an average of 10.5 mg/L, were used.

A recirculation system (RAS) was used to biologically control NH3 and NO2—and partial water exchanges were completed as required to control NO3—. The initial stocking density was approximately 21,000 post-larvae shrimp in each case, with an estimated 25% loss on planting for an expected 15,750 live animals on Day 1.

In Trial 1, shrimp were grown for 90 days and the mean final harvest weight was 40 grams as shown in graph 201. Traditional bubble aeration using venturis was used to achieve 7 mg/L DO until the oxygen demand could not be met (i.e., during the last seven days). When the DO dropped dangerously low, approaching 2 mg/L, farm staff reported an increase in mortality. Elective partial shrimp harvests were completed to help maintain acceptable dissolved oxygen concentrations.

For Trial 2, the venturi air inlets were sealed, and a DGI skid-mounted aeration machine manufactured by Fuel Tech, Inc. was used to provide a DO concentration at 150% of atmospheric saturation. In this trial, excellent survival and growth was achieved with an expected biomass loading in excess of 7 kg/m², a mean weight of 39 grams in 90 days as shown in graph 202 and a survivability in excess of 90%. The growth curve in this trial showed no significant difference with a similar trial completed at a much lower biomass loading. This increase in production, due to the higher stocking density, was accomplished while also decreasing the estimated mortality.

Other observations from the trial include no evidence of trimethyl amine odor at harvest, no evidence of oxidation, no evidence of toxicity, and no evidence of gas bubble disease, suggesting that maintaining dissolved oxygen levels above saturation without the presence of bubbles increases the yield while minimizing detrimental effects of high oxygen levels.

The DGI system includes technology for injecting a pressurized and oxygenated slipstream back into a body of water (i.e., the water in which the shrimp are grown). As the receiving body of water is at a lower pressure, the DGI effluent is introduced in a way that both rapidly distributes the oxygenated water and produces only transient bubbles of sufficiently small size to minimize oxygen loss via rise rate to the water surface. The DGI injection system includes multiple zones of injection as needed to optimize the distribution and dispersion of the DO in the process stream being treated.

Post-larvae shrimp (PLs) were stocked on Day 1. Oxygen demand was relatively low in the early part of the demonstration. In fact, the average oxygen demand during the first five days was less than 0.7 lbs./day. Although there was some small oxygen demand by the PLs and any bacteria in the water, the maximum assumption for oxygen lost to the atmosphere through the water surface was estimated to be 0.7 lbs./day. As the DO was consistently above the atmospheric saturation of 7 mg/L, some small loss is expected even though the DGI injectors are specifically designed to minimize mixing in the vertical water column.

The oxygen demand 301 and corresponding process water flow 302 is shown for the entirety of the demonstration period in FIG. 3. The oxygen demand was affected by the quantity and size of the shrimp, the bacterial activity in the raceway, a few water replacements to control nitrate concentrations, and a few early harvests of shrimp for marketing and business development purposes. As illustrated, there are large variations in oxygen demand 302 due to the current requirements in the shrimps' growth cycle.

As expected, the demand for dissolved oxygen increased as the shrimp grew, and the DGI system utilized more processed water. The water varied from about 0.7 gallons per minute (gpm) in the early stages to 4.5 gpm in the final weeks of the growth cycle. All of the water came from the raceway and was returned to the raceway.

Looking in detail at the near-linear portion of the shrimp growth and the elective harvests in the final weeks, it is possible to estimate the shrimp biomass throughout the demonstration period. An estimated average growth rate of 3.8 grams per week was calculated. The biomass is expected to increase with shrimp weight, decrease due to some typical small shrimp mortality, and decrease when elective harvests decrease the shrimp population in the raceway. In the absence of any elective harvesting, it was estimated the shrimp weight would have reached about 4.0 kg/m² by the final day of the cycle.

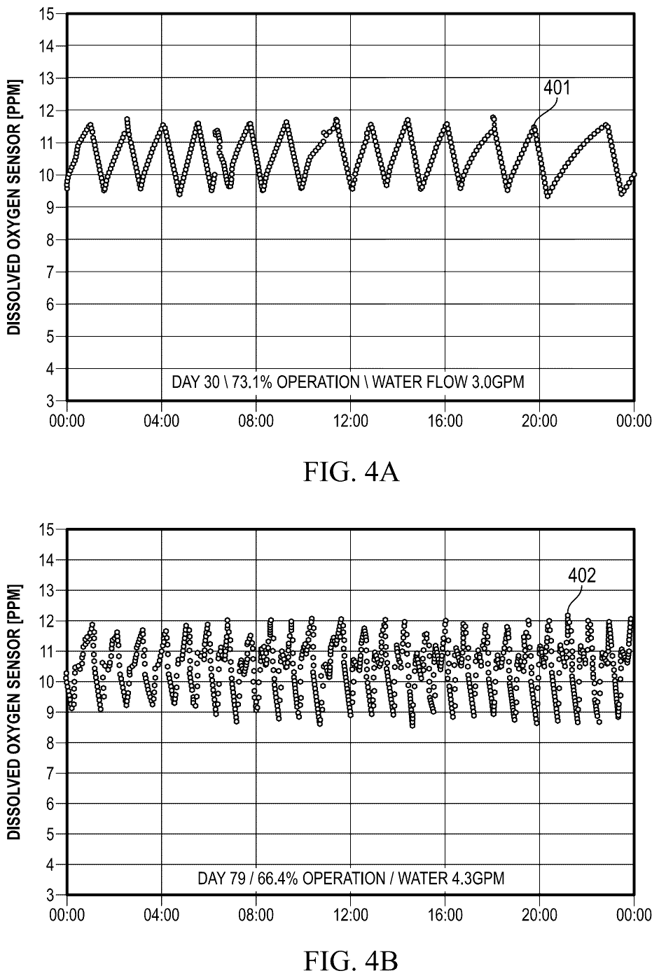

Looking more closely at the data, FIG. 4A shows the DO trend 401 in the raceway on Day 30 when the shrimp averaged about 3 grams, and the total biomass loading was only ˜0.35 kg/m². The DO 401 was consistently held between 9.5 mg/L and 11.5 mg/L and required about 14 cycles of infusion throughout the day.

On Day 79, the shrimp average weight was about 30 grams and the total biomass loading was 2.4 kg/m². The DO 402 was still held reliably between 9.5 mg/L and 11.5 mg/L but required more water and 26 cycles of infusion (see FIG. 4B). Notably, the DO 402 was held constant even though the weight of the shrimp increased.

In other embodiments, the PLC may be configured to set and maintain the oxygen infusion level between 1 mg/L and 50 mg/L. For example, the PLC may be set to maintain oxygen infusion levels at 2 mg/L to 20 mg/L or at an appropriate range for the animals being raised in the raceway. When raising shrimp, the oxygen infusion level may be maintained at 6.5 mg/L to 11.5 mg/L in one embodiment. During the test scenarios described herein, the PLC was set to maintain the oxygen infusion level at 9.5 mg/L to 11.5 mg/L.

Note that it is possible to tune the DGI system to deliver dissolved oxygen more slowly and to attempt to match the rate at which the oxygen is being depleted whether the shrimp are 3 grams or 30 grams in size. However, it is important to minimize rapid and/or large changes in oxygen levels to avoid stressing the shrimp, which can kill them.

Reliable DO dosing with automatic controls dramatically increased total production capability as compared to venturi induced-air bubbles. This unlocks future developments in raceway design and DGI system controls to support a fully automated process. The DGI system has now been shown to be effective in land-based aquaculture.

The traditional concept of aeration is simple. By physically agitating the water surface, ambient atmospheric gas, including oxygen, is dissolved into the water's topmost layers. Bubbles so generated are large and rise to the surface rapidly, not allowing for gas exchange, and such aeration results in an average dissolved gas of just three percent of oxygen per foot of water. Moreover, what oxygen is exchanged is concentrated in the topmost layers of water, above which most cultured shrimp or fish spend their days. The consequent lack of oxygen at the bottom prevents aerobic nitrifying bacteria from breaking down nitrogenous waste products, anaerobic conditions, and thus rapidly deteriorating water. Notably, as water temperature and salinity are increased the amount of oxygen becomes even more restrictive. Shrimp can survive at a DO of 2-4 mg/L but they do not thrive. A DO of 5 mg/L is acceptable, but higher stocking numbers are prohibited.

Shrimp production is dependent on a reliable aeration system and a denitrification process. The DGI system has been shown to meet land-based aquaculture requirements. Aside from aeration, the land-based shrimp industry faces challenges related to water quality and environmental impact, particularly the accumulation of nitrogenous wastes.

Denitrification can be achieved biologically or alternatively by combined chemical and mechanical means. However, denitrification issues are, at best, difficult to control, and reliance on an anoxic condition and a suitable carbon source is required to maintain viability. For the studies above, water exchange avoided accumulating toxic nitrogenous waste products.

### Reconfigured and Upgraded GEN-2 Shrimp Production Raceways

The GEN 2 shrimp production system presented in U.S. Pat. Nos. 11,206,817, 11,617,354 was reconfigured and upgraded in view of the information learned during the Trials noted above. The foundation of a shrimp grow out system is a production sub-unit, i.e., a raceway. A production unit is comprised of eight vertically stacked production sub-units (raceways).

The early trials described in U.S. Pat. Nos. 11,206,817, 11,617,354 showed that raceways installed in a Conex would be suitable for growing shrimp. Structural validation studies were carried out before moving forward with the design and fabrication of a larger production model. It was determined that Conex containers were not structurally strong enough to support raceways loaded with water. Consideration was given to reinforcement, but analysis showed it was more cost-effective to design and fabricate a purpose-built structure.

Conditions for sustainable shrimp production and structural requirements are of paramount importance. Fabrication materials, including fiberglass, plastics, and composite materials for raceway construction and shrimp toxicity, were evaluated; however, various reasons led to them all being found wanting. While initially discounted, steel fabrication is more than adequate for many other applications where constructs are exposed to marine environments.

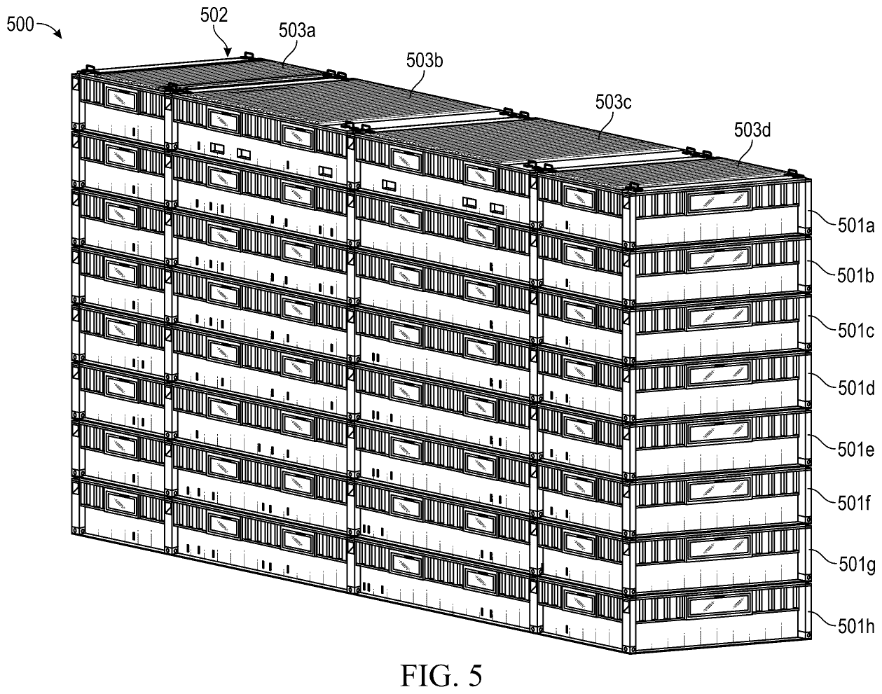

FIG. 5 illustrates a modular, scalable, resource-conserving aquaculture platform 500 according to an example embodiment. This design can be easily replicated to create multiple units. The aquaculture production system 500 comprises eight stacked raceways 501a-h. A cover 502 is affixed to the top of uppermost raceway 501a. Cover 502 comprises four sections 503a-d that can be attached or removed separately. Each of the lower raceways 501b-h are covered by the raceway above it. The raceways 501a-h are invariant, self-supporting, and sized to maximize shrimp production without complicating transport and installation.

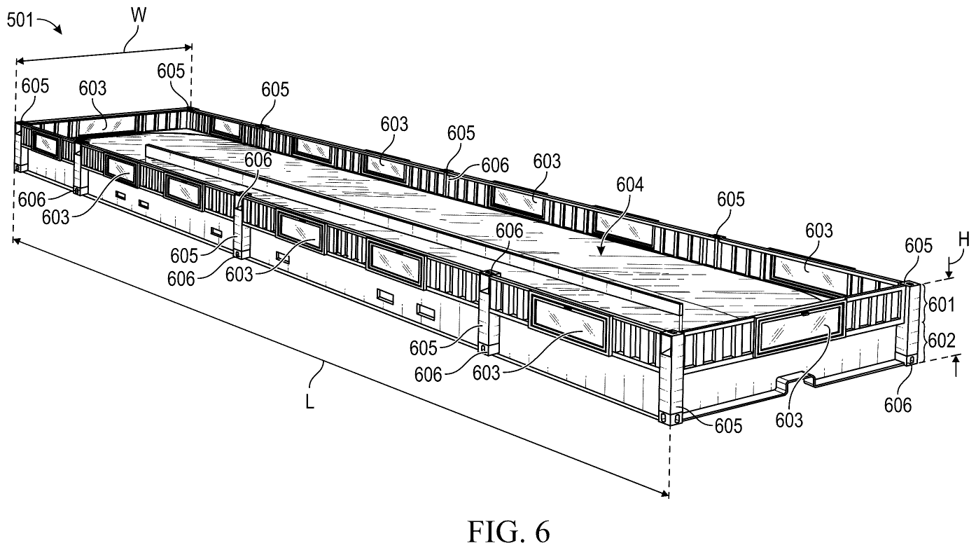

FIG. 6 illustrates an individual raceway 501, which can be positioned anywhere in the raceway stack 501a-h. Each raceway 501 has a rectangular shape with the following dimensions: L=60 feet long, W=12 feet wide, and H=3 feet high. Raceway 501 is generally equally divided into an upper portion 601 and a lower portion 602. The upper portion 601 of raceway 501 has a number of observation ports 603. The observation ports 603 may be framed plexiglass windows that provide visual access to the interior 604 of raceway 501. Load-bearing support beams 605 are arranged laterally along the side of raceway 501. These load-bearing beams 605 are placed to carry the weight of each raceway 501 and its contents. The load-bearing beams 605 are also strategically placed so as to distribute the weight of raceways 501a-h located above and below in the stack 500. To further strengthen a raceway stack and aid in support of the physical load, shipping container twist locks 606 are located at the bottom and top of each load-bearing support beam 605. When one raceway is placed atop a lower raceway, the twist locks 606 can be closed. When locked together, the two raceways 501 form a self-supporting structure of substantial strength.

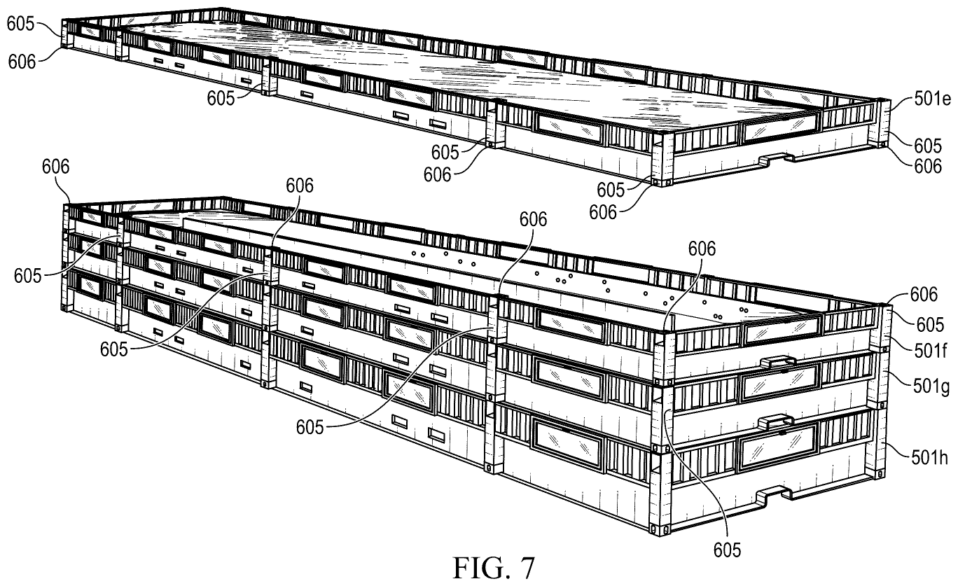

FIG. 7 illustrates the process of stacking raceways 501. As shown, raceway 501e is being placed on top of three stacked lower raceways 501f-h. Once raceway 501e is placed on raceway 501f, twist locks 606 located on the bottom of raceway 501e and on the top raceway 501f can be closed so that each load-bearing support beam 605 is locked together with the beams above and below.

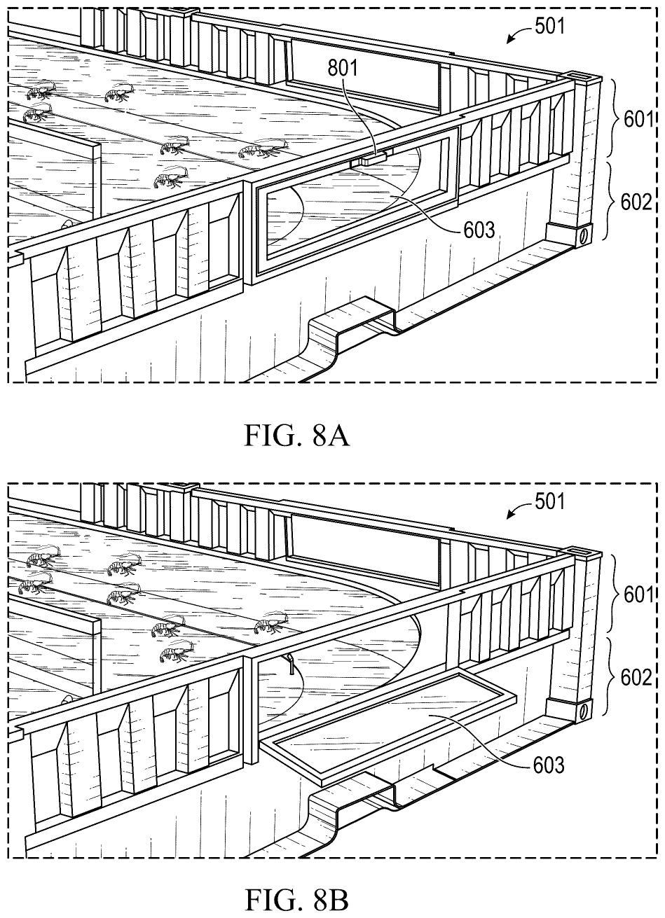

FIGS. 8A and 8B illustrate the operation an observation port 603. Generally, the bottom portion 602 of the raceway 501 is filled with water and shrimp or fin fish. Observation ports 603 are located in the top portion 601 of raceway 501. The observation ports 603 may be closed (FIG. 8A) to provide an enclosed environment within the interior 604 of raceway 501 (i.e., when another raceway or a cover 502 is attached above raceway 501). Alternatively, observation port 603 may be opened (FIG. 8B) to allow for access to interior 604 of raceway 501. Observation port 603 allows users to add food, add or remove animals (e.g., shrimp or fin fish), remove waste, test or sample water, perform maintenance, etc. Observation port 603 may include a handle or lock 801 to secure the observation port 603 in a closed position.

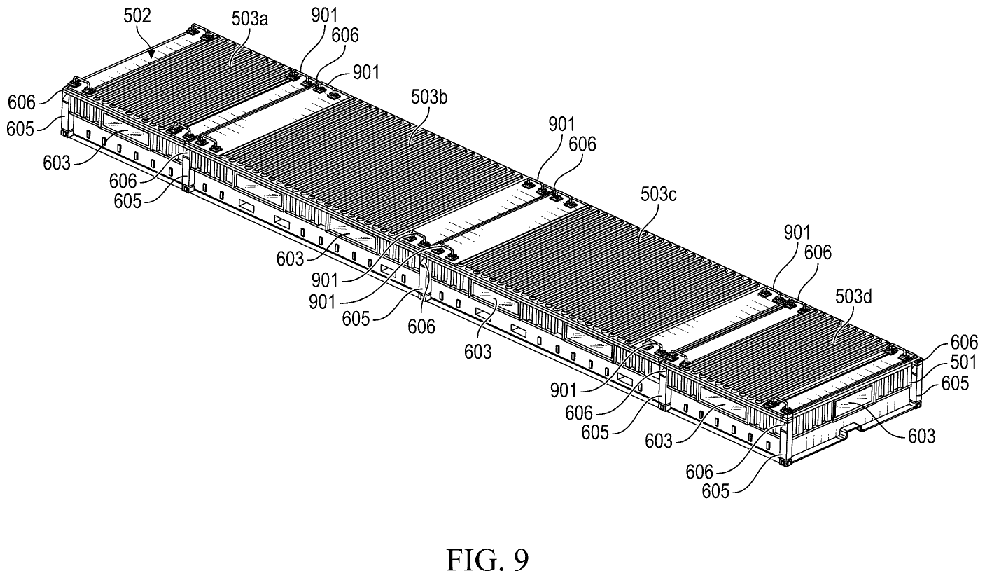

FIG. 9 illustrates cover 502 installed on a raceway 501, which may be a standalone raceway or the top-most raceway in a stack 500 (FIG. 5). Cover 502 comprises four sections 503a-d. In the illustrated embodiment, center sections 503b,c are 20′ long and outer sections 501a,d are 10′ long. In other embodiments cover 502 may comprise a single section or may be divided into more or less sections. As illustrated, the four-piece assembly 502 fully covers the raceway 501. Cover 502 may be attached to raceway 501 using the same locking points 606 that are used to lock existing raceways together. Cover 502 may be constructed from the same materials (e.g., steel fabrication) as used for raceway 501 to optimize resources and for ease of maintenance and handling.

Cover 502 is designed using a modular concept that reduces handling operations to a minimum, while securing the upper raceway 501 from external contamination risks. Cover 502 provides easy access to all sections of raceway 501 for inspection when needed. The individual cover pieces 503a-d may overlap each other to provide sufficient closure for the upper raceway 501 while taking as little space as possible. The twist locks 606 can be used as guides and as latching tools to secure cover 502 to the raceway 501. Handles 901 are attached to each cover section 503a-d to assist in lifting the raceway cover.

The cover 502 prevents loss of moisture and heat from the raceways. This lowers energy consumption and costs for the raceways. Cover 502 also prevents shrimp (or fin fish) from jumping out of the raceway water. Only the top raceway needs a cover since each raceway acts as a cover for the raceway below it.

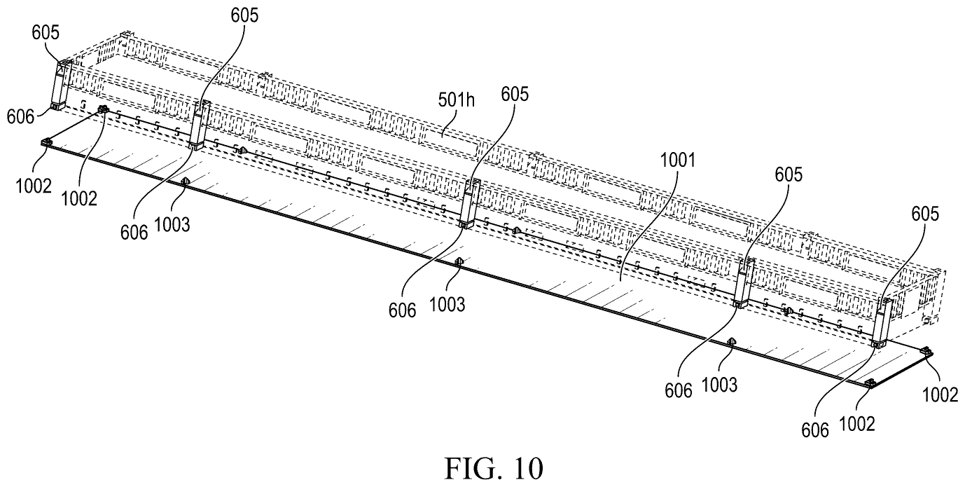

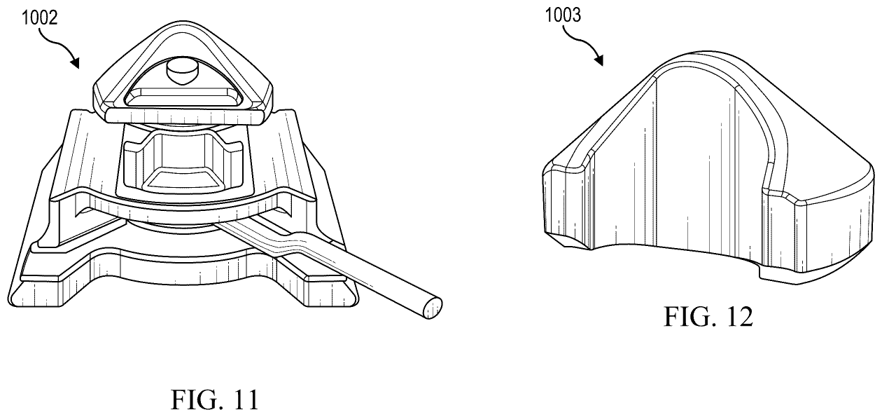

FIG. 10 illustrates a caisson structure 1001 on which raceways can be mounted according to one embodiment. A number of locking components are welded to caisson 1001. Four dovetail twist locks 1002 (FIG. 11) are located on each corner of caisson 1001, and six stacking cones 1003 (FIG. 12) are located on edge of caisson 1001 between twist locks 1002. The stacking cones function as intermediate latching points. The twist locks 1002 and stacking cones 1003 are aligned with twist locks 606 on the bottom of each load-bearing support beam 605 for bottom raceway 501h. The locking components 1002, 1003 are welded to interface steel plates of 200×200 mm. The interface steel plates are bolted, welded, or embedded in concrete (depending on the caisson design). This way, the entire eight-runway-high stack is locked down to the caisson structure 1001 and lateral movement of the raceways 501a-h is reduced to zero.

In one embodiment, the dovetail twist locks 1002 are manufactured from a heat-treatable steel material with a hot dip galvanized finish. The stacking cones 1003 are manufactured from a forged steel material with a shop primer finish. The dovetail twist locks 1002 and stacking cones 1003 have a breaking load of 420 KN (shear). The twist locks and stacking cones make sure there is no possibility of sheer that could result in misalignment of the stack.

Cassion 1001 may be a virtual plate that has the same dimensions as the bottom of a raceway 501h. In one embodiment, ten screw piles (not shown) are bored into the sub-surface floor on which the stacked raceways are to be assembled and housed. The piles are engineered to hold the weight of the production unit, including the water in which the shrimp are maintained.

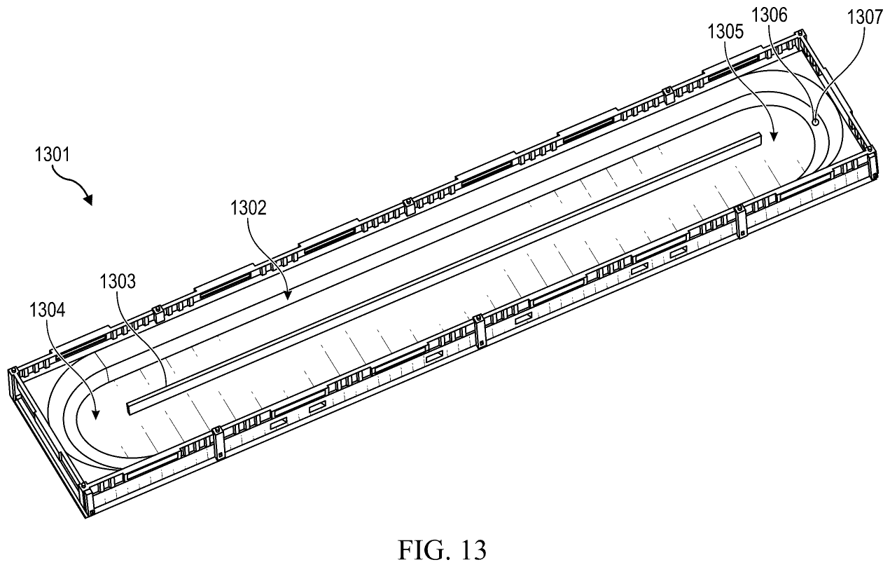

FIG. 13 is an isometric top view of a raceway 1301, which can be used as stacked raceways 501 in an example embodiment. Each raceway 1301 has a linear basin-like structure 1302 running laterally along the length of the raceway. In the center of the basin 1302, running laterally along the length of raceway 1301 is a vertical barrier 1303 that demarcates the width of the basin 1302 into two halves. The barrier 1303 extends from a crescent-shaped endcap 1304 to the lip of the harvest pit 1305. The harvest pit 1305 is structurally distinct with respect to the main portions of the basin 1302.

The harvest pit 1305 is shaped like a crescent or fan. The fan is angled tangentially down to a lowest point where two valves 1306, 1307 are located. Valves 1306 and 1307 are controlled by actuators. A first valve 1306 (i.e., a screen valve) controls a screen (not shown) that is sized to retain shrimp in the raceway basin 1302. Waste and detritus passing through the screen when valve 1306 is open are diverted to water reprocessing. A second valve 1307 (i.e., a gate valve) is situated below the screen valve 1306 and remains closed during the water reprocessing process. When the screen valve 1306 and gate valve 1307 are both opened, water from basis 1302 as well as shrimp growing in basin 1302 drain freely from raceway 1301. The water and shrimp are diverted to a water separator (not shown) that diverts the water to a reprocessing system and the shrimp into a collection tank, such as an ice cold tank filled with fresh water.

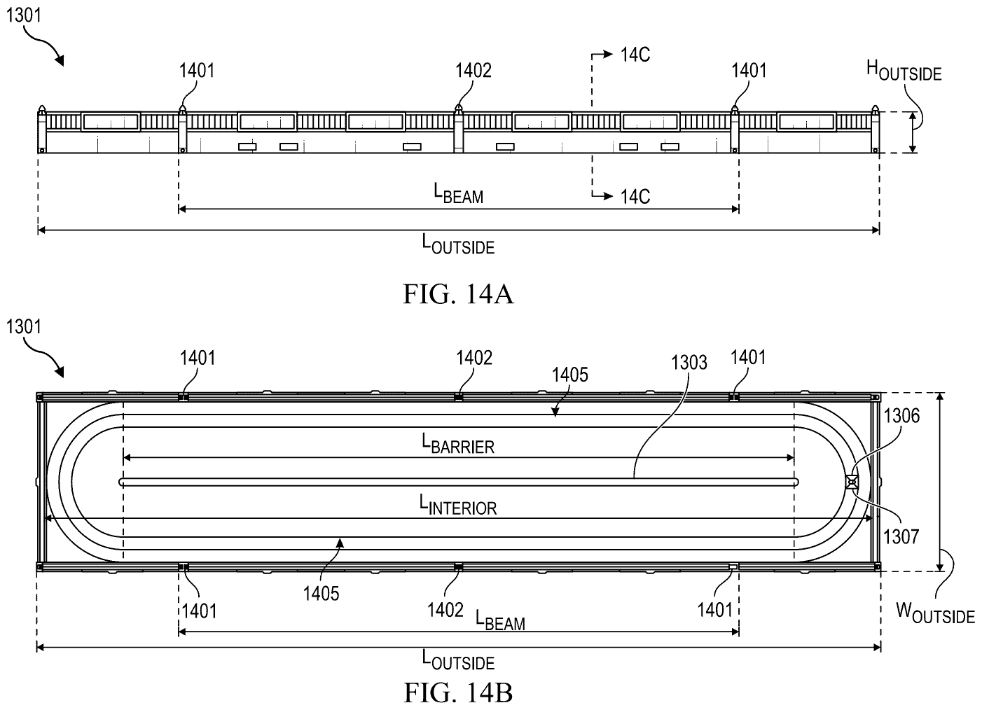

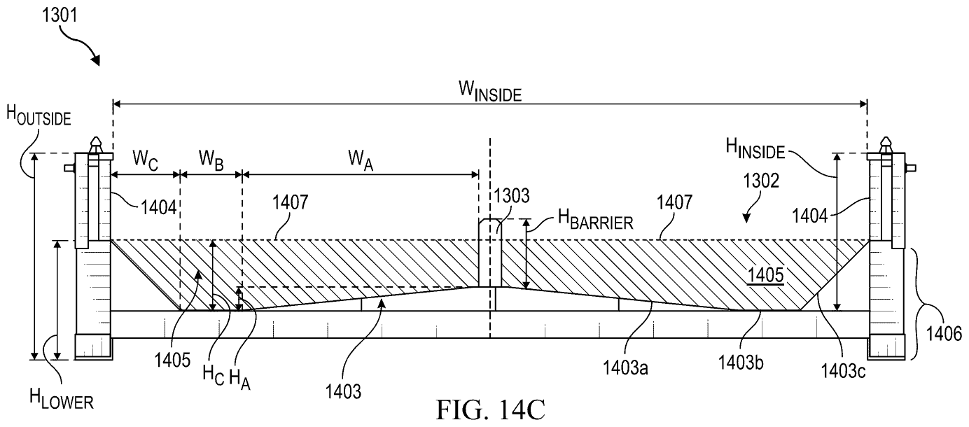

FIGS. 14A-C provide top, side, and cross section views of raceway 1301 along with dimensions according to an example embodiment. Raceway 1301 has an overall outer length L_{outside} of 18.288 m (60′), an outer width W_{outside} of 3.656 m (12′), and a height H_{outside} Of 91.44 cm (3′). Load-bearing support beams 1401 are separated by a length L_{beam} of 12.192 m and are centered around center support beams 1402. Raceway 1301 has an interior length Lᵢₙₜₑᵣᵢₒᵣ of 18.052 m. Central barrier 1303 has a length L_{barrier} of 14.580 m.

The inside height H_{inside} of raceway 1301 is 692 mm, and the inside width W_{inside} is 3.332 m. The height H_{barrier} of barrier 1303 is 305 mm. The width of barrier 1303 tapers from 152 mm to approximately 100 mm.

As illustrated in the cross section view of FIG. 14C, the floor 1403 of basin area 1302 has three sections. A first sloped section 1403a ramps down from barrier 1303 to a flat section 1403b before a second sloped section 1403c ramps sharply back up to inner wall 1404. The first sloped section 1403a has a height Ha of 102 mm and a width Wₐ of 990 mm. The flat section 1403b has a width Wb of 305 mm. The second sloped section 1403c has a height H_{c} of 305 mm and a width W_{c} of 305 mm. It will be understood that these measurements are provided for one embodiment and that other embodiments are not limited to the measurements or proportions illustrated in FIGS. 14A-C.

Floor section 1403c has a 45 degree slope and basically functions as both a floor and a sidewall for basin 1302. Floor section 1403a surrounding center barrier 1303 slopes downward at a shallow ten-degree angle to the raceway floor 1403b. Effectively, these opposed sloped sections create an impediment-free channel 1405 surrounding the bottom of the raceway 1301. The channel 1405 is designed to require a minimal energy consumption for water circulation while having maximal energy efficiency. Smooth water circulation is very important in that it facilitates feed distribution, oxygenation, and maintenance and prevents the buildup of detritus. The slope of the outer and inner portions of the floor forces unconsumed feed to the middle of the channel and to prevent it from stacking up along the sides of the raceway.

Aside from the physical elements that comprise the lower half 1406 of raceway 1301, the maximal water level 1407 when filled is approximately 18″. However, operationally, water would typically be kept at 12″ to 15″ and center barrier 1303 maintains water circulation in a counterclockwise rotation. In other embodiments, water may circulate in a clockwise rotation.

Since all raceways 1301 are self-supporting and invariant, they can be easily stacked. Based on shrimp production models, a production unit consisting of eight stacked raceways (500, FIG. 5) best fit trial parameters. Structurally, each raceway 1301 is locked to raceways above and/or below by twist locks. The twist locks are located at each beam support located around the perimeter of each raceway.

The configuration of the production module is presented in detail above. The design and construction of shrimp production modules are described in detail above. Many features beneficial to shrimp production have been designed into the eight-stack production module. However, shrimp production is a biological process. The biological requirements encompass the maintenance of environmental temperature, salinity, aeration, feed distribution, and removal of nitrogenous waste products. The production stack and components thereof were configured to facilitate the physical and biological aspects of shrimp production. Furthermore, while example embodiments described herein refer to shrimp production, it will be understood that other aquaculture systems, such as those used for fin fish or other animal production, may use the stacked raceway configuration disclosed herein.

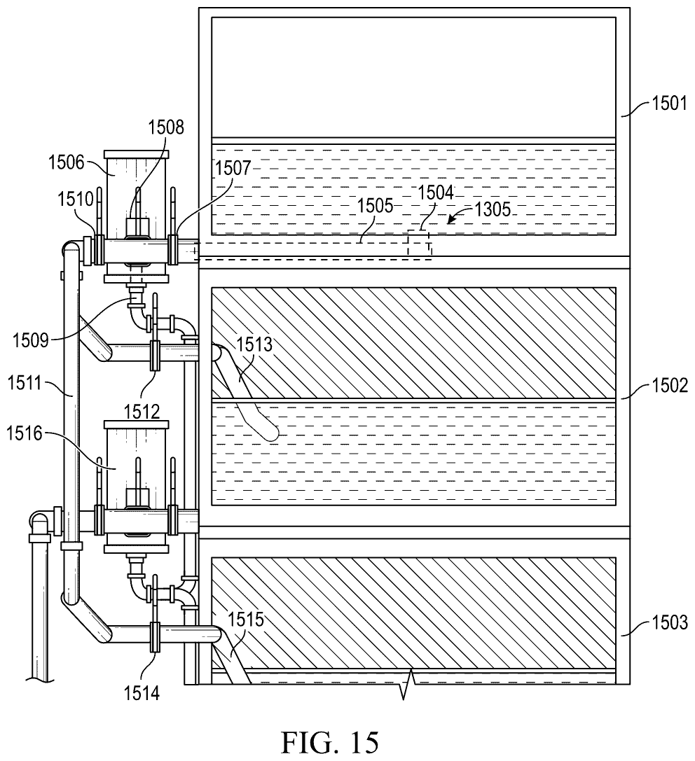

FIG. 15 illustrates plumbing for removing water, waste, and animals from raceways. Three stacked raceways 1501-1503 are shown. Each raceway 1501-1503 is configured to hold water and shrimp in a lower section as described above. A drain 1504 is located in a harvest pit area 1305 of raceway 1501. The harvest pit 1305 is angled down to a lowest point where drain 1504 is located. Water can be drained from raceway 1501 through pipe 1505 to water separator 1506 by opening first valve 1507. A second valve 1508 is opened to route waste to pipes 1509, which may route water to a sludge precipitation box (e.g. 113, FIG. 1) or to another water reprocessing system. A third valve 1510 is opened to route shrimp from raceway 1501 to other raceways via pipe 1511. Valve 1512 is opened to route shrimp into raceway 1502, for example, via pipe 1513. Similarly, valve 1514 is opened to route shrimp into raceway 1503 via pipe 1515. Water separator 1516 operates in a similar manner to remove water, waste, and shrimp from raceway 1502.

Shrimp grown from the PL stage to harvest using the DGI system benefit from a precisely controlled environment where DO levels are maintained at optimal set points. The DGI system allows for the infusion of high-purity oxygen into the water, ensuring that the DO levels can be set and maintained consistently throughout the shrimp's growth cycle. This precise control is crucial as it allows the DO set point to be adjusted according to the biomass of the shrimp, ensuring that both lower and higher biomass conditions are adequately supported. At lower biomass, the system can maintain a lower DO set point, which is sufficient for the smaller oxygen demands of the young shrimp. As the shrimp grow and their biomass increases, the DGI system can adjust to maintain a higher DO set point, meeting the increased oxygen demands of the larger shrimp. This flexibility in maintaining the DO set point ensures that the shrimp experience minimal stress and optimal growth conditions, leading to higher survival rates, faster growth, and improved overall health from the post-larvae stage to harvest.

The DGI system significantly reduces the amount of oxygen required compared to traditional bubble aeration processes. In a bubble process, a substantial portion of the oxygen is lost to the atmosphere as the bubbles rise to the surface, resulting in inefficient oxygen transfer. In contrast, the DGI system infuses high-purity oxygen directly into the water as dissolved oxygen, ensuring that nearly all the oxygen is available for the shrimp. This method not only enhances the efficiency of oxygenation but also minimizes oxygen wastage. Consequently, the pounds of oxygen used in the DGI system are significantly lower, leading to cost savings and more sustainable shrimp farming operations.

In an example arrangement, a system for land-based aquaculture comprises a gas infusion system configured to infuse bioavailable oxygen into water, and at least one raceway comprising one or more injectors coupled to the gas infusion system and configured to introduce oxygen-infused water into the raceways.

In another example arrangement, the system further comprises a plurality of raceways arranged in a vertical stacked configuration, each raceway further comprising a rectangular structure with an upper portion and a lower portion, and a basin structure formed in the lower portion of the raceway, the basin having a central vertical barrier and configured to circulate water around the barrier.

In a further example arrangement, the system further comprises a drain in each raceway, and a water reprocessing system coupled to the drain and configured to receive water from the raceways, the water reprocessing system comprising filters for removing solids and nitrogenous byproducts from water, and pumps for circulating water through the system.

In another example arrangement, the gas infusion system and the water reprocessing system are configured to maintain optimal water quality and bioavailable oxygen levels for shrimp production.

In a further example arrangement, the system further comprises a cover for a topmost raceway in the vertical stack, the cover comprising multiple overlapping sections configured to provide closure to the topmost raceway and to prevent external contamination.

In another example arrangement, the gas infusion system is configured to achieve an oxygenation level in the slipstream of water of up to 300 pounds per square inch gauge (psig).

In a further example arrangement, the gas infusion system further comprises one or more oxygen tanks connected to a saturator.

In another example arrangement, the raceways further comprise load-bearing support beams arranged laterally along the sides of the raceway.

In a further example arrangement, the raceways further comprise twist locks located at the top and bottom of each load-bearing support beam for securing the raceway to adjacent raceways in a vertical stack.

In another example arrangement, the raceways further comprise a harvest pit located at one end of the basin structure.

In a further example arrangement, the raceways further comprise a drain hole in the basin structure, a first valve coupled to the drain hole and configured to control a screen that is sized to retain animals in the basin, wherein, when the first valve is open, the screen is adapted to divert waste and detritus to a water reprocessing system, and a second valve coupled to the drain hole and configured to allow water and animals to drain from the raceway when opened.

In another example arrangement, the animals are shrimp or fin fish.

In a further example arrangement, the system further comprises one or more oxygen sensors configured to monitor oxygen levels in water in the raceways.

In another example arrangement, each oxygen sensor is positioned upstream of an injector located on a same side of the barrier.

In a further example arrangement, the injectors are controlled by a programmable logic controller (PLC) to adjust the rate of oxygen infusion based on real-time oxygen levels detected by the oxygen sensors.

In another example arrangement, the injectors are configured to introduce oxygen-infused water into the raceways at multiple locations along the length of the raceway.

In a further example arrangement, the injectors are designed to produce nanobubbles to maximize the surface area for oxygen transfer and enhance the efficiency of oxygenation.

In another example arrangement, the injectors are configured to operate at variable pressures to optimize the infusion of oxygen into the water based on the biomass and oxygen demand of animals growing in the water.

In a further example arrangement, the injectors are positioned to cause the water to circulate around the central barrier.

In another example arrangement, the basin structure has a racetrack shape centered around the central vertical barrier, the basin structure having a floor comprising a central flat portion, an inner sloped portion that rises from the flat portion to meet the central barrier, and an outer sloped portion that rises from the flat portion to meet an outer wall of the rectangular structure.

In a further example arrangement, the gas infusion system is configured to maintain optimal dissolved oxygen (DO) levels for shrimp growth from the post-larvae stage to harvest by adjusting a DO set point according to biomass of the shrimp.

In another example arrangement, the gas infusion system infuses oxygen directly into the water as dissolved oxygen (DO), thereby reducing the amount of oxygen required compared to traditional bubble aeration processes by ensuring that nearly all the oxygen is available to animals in the water.

In a further example arrangement, the PLC is configured to control the gas infusion system to maintain an oxygen infusion level at 2.0 to 20 mg/L.

In another example arrangement, the PLC is configured to control the gas infusion system to maintain an oxygen infusion level at 6.5 to 11.5 mg/L.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A system for land-based aquaculture, comprising:
a gas infusion system configured to infuse bioavailable oxygen into water; and
at least one raceways comprising:
one or more injectors coupled to the gas infusion system and configured to introduce oxygen-infused water into the raceways.

2. The system of claim 1, further comprising:
a plurality of raceways arranged in a vertical stacked configuration, each raceway further comprising:
a rectangular structure with an upper portion and a lower portion; and
a basin structure formed in the lower portion of the raceway, the basin having a central vertical barrier and configured to circulate water around the barrier.

3. The system of claim 1, further comprising:
a drain in each raceway; and
a water reprocessing system coupled to the drain and configured to received water from the raceways, the water reprocessing system comprising:
filters for removing solids and nitrogenous byproducts from water; and
pumps for circulating water through the system.

4. The system of claim 1, wherein the gas infusion system and the water reprocessing system are configured to maintain optimal water quality and bioavailable oxygen levels for shrimp production.

5. The system of claim 1, further comprising:
a cover for a topmost raceway in the vertical stack, the cover comprising multiple overlapping sections configured to provide closure to the topmost raceway and to prevent external contamination.

6. The system of claim 1, wherein the gas infusion system is configured to achieve an oxygenation level in the slipstream of water of up to 300 pounds per square inch gauge (psig).

7. The system of claim 1, wherein the gas infusion system further comprises:
one or more oxygen tanks connected to a saturator.

8. The system of claim 1, wherein the raceways further comprise:
load-bearing support beams arranged laterally along the sides of the raceway.

9. The system of claim 1, wherein the raceways further comprise:
twist locks located at the top and bottom of each load-bearing support beam for securing the raceway to adjacent raceways in a vertical stack.

10. The system of claim 2, wherein the raceways further comprise:
a harvest pit located at one end of the basin structure.

11. The system of claim 2, wherein the raceways further comprise:
a drain hole in the basin structure;
a first valve coupled to the drain hole and configured to control a screen that is sized to retain animals in the basin, wherein, when the first valve is open, the screen is adapted to divert waste and detritus to a water reprocessing system; and
a second valve coupled to the drain hole and configured to allow water and animals to drain from the raceway when opened.

12. The system of claim 11, wherein the animals are shrimp or fin fish.

13. The system of claim 2, further comprising:
one or more oxygen sensors configured to monitor oxygen levels in water in the raceways.

14. The system of claim 13, wherein each oxygen sensor is positioned upstream of an injector located on a same side of the barrier.

15. The system of claim 13, wherein the injectors are controlled by a programmable logic controller (PLC) to adjust the rate of oxygen infusion based on real-time oxygen levels detected by the oxygen sensors.

16. The system of claim 1, wherein the injectors are configured to introduce oxygen-infused water into the raceways at multiple locations along the length of the raceway.

17. The system of claim 1, wherein the injectors are designed to produce nanobubbles to maximize the surface area for oxygen transfer and enhance the efficiency of oxygenation.

18. The system of claim 1, wherein the injectors are configured to operate at variable pressures to optimize the infusion of oxygen into the water based on the biomass and oxygen demand of animals growing in the water.

19. The system of claim 2, wherein the injectors are positioned to cause the water to circulate around the central barrier.

20. The system of claim 2, wherein the basin structure has a racetrack shape centered around the central vertical barrier, the basin structure having a floor comprising:
a central flat portion;
an inner sloped portion that rises from the flat portion to meet the central barrier; and
an outer sloped portion that rises from the flat portion to meet an outer wall of the rectangular structure.

21. The system of claim 1, wherein the gas infusion system is configured to maintain optimal dissolved oxygen (DO) levels for shrimp growth from the post-larvae stage to harvest by adjusting a DO set point according to biomass of the shrimp.

22. The system of claim 1, wherein the gas infusion system infuses oxygen directly into the water as dissolved oxygen (DO), thereby reducing the amount of oxygen required compared to traditional bubble aeration processes by ensuring that nearly all the oxygen is available to animals in the water.

23. The system of claim 15, wherein the PLC is configured to control the gas infusion system to maintain an oxygen infusion level at 2.0 to 20 mg/L.

24. The system of claim 15, wherein the PLC is configured to control the gas infusion system to maintain an oxygen infusion level at 6.5 to 11.5 mg/L.
